(19) United States
(12) Patent Application Publication
(10) Pub. No.: US 2012/0014584 A1
(43) Pub. Date: Jan. 19, 2012

(54) METHOD AND APPARATUS OF PROCESSING IMAGE AND MEDICAL IMAGE SYSTEM EMPLOYING THE APPARATUS

(75) Inventors: Seok-min Han, Seongnam-si (KR); Dong-goo Kang, Suwon-si (KR); Sung-su Kim, Yongin-si (KR); Hyun-hwa oh, Hwaseong-si (KR); Jae-mock Yi, Hwaseong-si (KR); Young-hun Sung, Hwaseong-si (KR); Jong-ha Lee, Hwaseong-si (KR); Kwang-eun Jang, Busan (KR)

(73) Assignee: SAMSUNG ELECTRONICS CO., LTD., Suwon-si (KR)

(21) Appl. No.: 13/181,866

(22) Filed: Jul. 13, 2011

(30) Foreign Application Priority Data
Jul. 15, 2010 (KR) 10-2010-0068674

(51) Int. Cl. G06K 9/00

(52) U.S. Cl. 382/132

(57) ABSTRACT

A method of processing an image is provided. The method includes generating a calibration model by learning an intensity-target data set obtained from a parameter of a test subject; and estimating a target. The estimating includes applying the calibration model to a parameter of an input subject and calibrating the parameter of the input subject.

### CROSS-REFERENCE TO RELATED APPLICATIONS

This application claims the benefit of Korean Patent Application No. 10-2010-0068674, filed on Jul. 15, 2010, in the Korean Intellectual Property Office, the entire disclosure of which is incorporated herein by reference for all purposes.

### BACKGROUND

1. Field

The following disclosure relates to a method and apparatus for processing an image, and a medical image system employing the apparatus.

2. Description of the Related Art

In radiography that uses dual energy, calibration of an image processing apparatus is generally performed using a wedge phantom having a stepped shape or a triangular shape, and by estimating a functional relation between a dual energy logarithm signal corresponding to a negative logarithm of a signal output from a radiography detector, and a thickness of an object to be imaged. The estimated functional relation obtained from the performing of the calibration may allow a dual energy radiation image to be converted into a material ratio and a material thickness.

### SUMMARY

Provided are methods and apparatuses for processing an image, wherein an input parameter obtained from a dual energy radiation image is processed by applying a calibration model.

Provided are medical image systems employing the apparatuses.

Additional aspects will be set forth in part in the description which follows and, in part, will be apparent from the description, or may be learned by practice of the presented embodiments.

According to an aspect of the present invention, a method of processing an image is provided. The method includes generating a calibration model by learning an intensity-target data set obtained from a parameter of a test subject, and estimating a target. The estimating includes applying the calibration model to a parameter of an input subject and calibrating the parameter of the input subject.

The parameter of the test subject may be intensity obtained from a dual energy radiation image of a phantom for calibration, and the parameter of the input subject is intensity obtained from a dual energy radiation image of the input subject.

The parameter of the test subject may include additional information about the phantom for calibration, and the parameter of the input subject comprises additional information about the input subject.

The additional information may be information about total thicknesses of the phantom for calibration and the input subject, and different calibration models may be selected according to the total thickness of the input subject.

The generating may include learning the intensity-target data set by using support vector regression (SVR).

The phantom for calibration may be formed by overlapping at least two ramp wedge phantoms formed of at least two materials.

The method may include when the parameter of the input subject exists outside an intensity range used while generating the calibration model, projecting the parameter of the input subject within the intensity range used while generating the calibration model, and calibrating the parameter of the input subject with an intensity closest to the parameter of the input subject.

One of the two materials may be polycarbonate and another of the two materials may be polyethylene.

According to another aspect of the present invention, an apparatus for processing an image is provided. The apparatus includes a calibration model generating unit configured to generate a calibration model by learning an intensity-target data set obtained from a parameter of a test subject, and a target estimating unit configured to estimate a target. The estimating includes applying the calibration model to a parameter of an input subject and calibrating the parameter of the input subject.

The calibration model generating unit may include an intensity-target mapping unit configured to obtain the intensity-target data set by mapping intensity and the target obtained from the parameter of the test subject, and a learning unit configured to learn the intensity-target data set by applying a regression analysis to the intensity-target data set.

The parameter of the test subject may be intensity obtained from a dual energy radiation image of a phantom for calibration, and the parameter of the input subject is intensity obtained from a dual energy radiation image of the input subject.

The parameter of the test subject may include additional information about the phantom for calibration, and the parameter of the input subject comprises additional information about the input subject.

The additional information may include information about total thicknesses of the phantom for calibration and input subject, and different calibration models may be selected according to the total thickness of the input subject.

The apparatus may include when the parameter of the input subject exists outside an intensity range used while generating the calibration model, the target estimating unit projects the parameter of the input subject within the intensity range used while generating the calibration model, and calibrating the parameter of the input subject with an intensity closest to the parameter of the input subject.

The parameters of the test subject and the input subject may be respectively intensities obtained from a radiation image.

The radiation image may include at least a first energy image and a second energy image.

The apparatus may be disposed in a remote place.

The phantom for calibration may be formed by overlapping at least two ramp wedge phantoms formed of at least two materials, and one of the two materials is polycarbonate and another of the two materials is polyethylene.

According to another aspect of the present invention, a method of processing an image is provided. The method includes generating an input parameter including intensities of first and second energy images, applying a calibration model to the generated input parameter, calibrating an error of the input parameter by applying the calibration model, and estimating a target based on the calibrated input parameter and the error.

Other features and aspects may be apparent from the following detailed description, the drawings, and the claims.

### BRIEF DESCRIPTION OF THE DRAWINGS

FIG. 1 is a block diagram illustrating an apparatus for processing an image according to an example embodiment;

FIG. 2 is a block diagram illustrating a calibration model generating unit of FIG. 1 according to an example embodiment;

FIG. 3 is a block diagram illustrating a calibration model generating unit of FIG. 1 according to another example embodiment;

FIG. 4 is a diagram illustrating a phantom for calibration including a continuous variable thickness, and the diagram illustrates a method of selecting a calibration model according to an example embodiment;

FIG. 5 is a diagram illustrating data within a range and data outside the range;

FIGS. 6A and 6B are graphs illustrating intensity-thickness relations respectively mapped with respect to a single total thickness and two types of a total thickness;

FIG. 7 is a graph illustrating an image calibration method according to an example embodiment; and

FIG. 8 is a flowchart illustrating a method of processing an image, according to an example embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

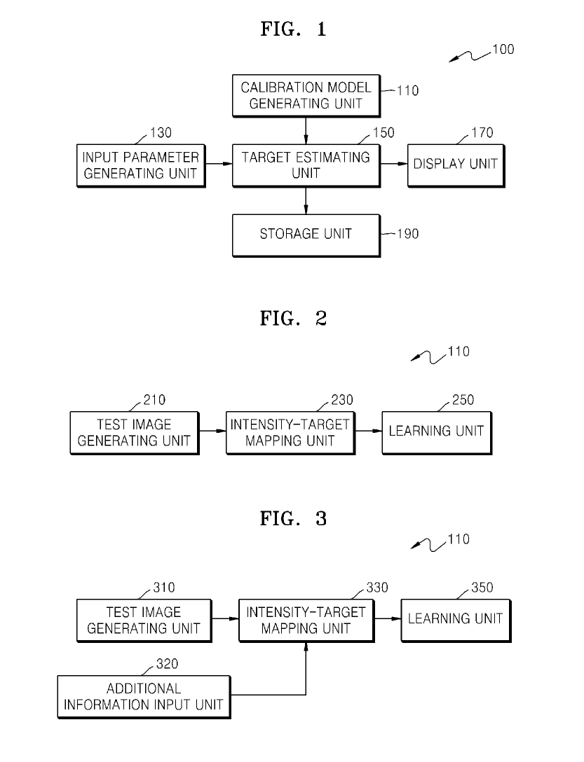

FIG. 1 is a block diagram illustrating an apparatus 100 configured to process an image, according to an example embodiment. The apparatus 100 includes a calibration model generating unit 110, an input parameter generating unit 130, and a target estimating unit 150. In the example embodiment, the calibration model generating unit 110 and the target estimating unit 150 may be implemented by at least one processor. Meanwhile, the apparatus 100 may optionally include a display unit 170, which may be implemented as a monitor or the like, and a storage unit 190, which may be implemented as a memory or the like. The apparatus 100 may further include a communicator (not shown) configured to transmit intensity-target information estimated from an input subject to a medical image system disposed in a remote place by a wired or wireless network, and receive a parameter of the input subject from outside the apparatus 100 by the wired or wireless network.

Referring to FIG. 1, the calibration model generating unit 110 may be configured to generate a calibration model by learning an intensity-target data set obtained from a parameter of a test subject. Here, the parameter of the test subject may be an intensity obtained from a dual energy radiation image of a phantom for calibration. For example, the intensity may be obtained from at least each of a first energy image constituting a high energy image, and a second energy image constituting a low energy image. The intensity may represent a gray scale level or a brightness value of each pixel. A combination of intensities may be mapped to an actual thickness of a predetermined material forming the test subject to form the intensity-target data set. In this example, the parameter of the test subject may further include additional information corresponding to a total thickness of the test subject, in addition to the intensity that may have been obtained from the dual energy radiation image. By further including the additional information related to the total thickness of the test subject as the parameter of the test subject, different calibration models may be generated in response to the total thickness of the test subject while considering a different total thickness of the test subject. Accordingly, an estimation error may be remarkably reduced in response to the different total thickness of the test subject.

Meanwhile, a regression analysis may be applied while learning the intensity-target data set. More specifically, a support vector regression (SVR) may be applied, as the regression analysis, but any other method may be used to learn the intensity-target data set.

In this example, the phantom for calibration used as the test subject may be formed by overlapping at least two ramp wedge phantoms formed of at least first and second materials. When the dual energy radiation image is used for mammography, the first and second materials may be 1) polycarbonate corresponding to a glandular tissue and 2) polyethylene corresponding to an adipose tissue, respectively. When a total thickness of the phantom for calibration is uniform, the first and second materials may be combined in all possible ratios of thickness.

For example, when the total thicknesses of the test subject are 3 cm, 4 cm, and 5 cm, respectively, an actual thickness of a predetermined material corresponding to an intensity combination of the first energy image (high) and the second energy image (low) may be shown in Tables 1 through 3 below according to each total thickness.

TABLE 1

| Actual Thickness | 1 mm | 2 mm | 3 mm | . . . |
|---|---|---|---|---|
| High | 15 | 20 | 24 | . . . |
| Low | 25 | 31 | 38 | . . . |

TABLE 2

| Actual Thickness | 1 mm | 2 mm | 3 mm | . . . |
|---|---|---|---|---|
| High | 12 | 17 | 21 | . . . |
| Low | 22 | 27 | 35 | . . . |

TABLE 3

| Actual Thickness | 1 mm | 2 mm | 3 mm | . . . |
|---|---|---|---|---|
| High | 10 | 15 | 22 | . . . |
| Low | 20 | 25 | 33 | . . . |

In other words, referring to Table 1, when the total thickness of the phantom for calibration of a compression paddle is 3 cm, the actual thickness of the first material, for example, the adipose tissue, forming the phantom for calibration is 1 mm.

The intensity-target data set may be formed in response to each total thickness of the test subject as described above, and the intensity-target data set according to each total thickness may be learned by performing a regression analysis on the intensity-target data set, thereby generating the calibration model according to each total thickness.

The input parameter generating unit 130 may generate the parameter of the input subject from the dual energy radiation image obtained with respect to the input subject. Here, the parameter of the input subject may be intensity obtained from the dual energy radiation image of the input subject. For example, the intensity may be obtained from each of at least a first energy image constituting a low energy image, and a second energy image constituting a high energy image. In this example, the parameter of the input subject may further include additional information related to a total thickness of the input subject, in addition to the intensity obtained from the dual energy radiation image. By further including the additional information related to the total thickness as the parameter of the input subject, different calibration models may be selected while considering different total thicknesses of the input subject to calibrate the parameter of the input subject. Accordingly, the addition information may allow calibration accuracy to be increased.

The target estimating unit 150 may estimate a target corresponding to each combination of intensities by calibrating the parameter of the input subject by applying the calibration model to the parameter of the input subject. By including not only the intensities of the first and second energy images but also the total thickness of the input subject as the parameter of the input subject, the calibration model corresponding to the total thickness of the input subject may be selected. More specifically, the intensities of the first and second energy images may be received as the parameter of the input subject. If the combination of the intensities of the first and second energy images is outside a range of the intensity-target data set to which the calibration model belongs, a corresponding target may be estimated by calibrating the combination inside the range, by referring to a default calibration model or a selected calibration model and the intensity-target data set used to generate each calibration model. In other words, if the parameter of the input subject has an undefined value, the undefined value may be mapped to a value closest to a functional relation of 1) a thickness of the first material, 2) a thickness of the second material, 3) the intensity of the first energy image, and 4) the intensity of the second energy image, which are defined in the intensity-target data set used to generate the calibration model. Thus, by including the total thickness of the phantom for calibration as the additional information in addition to the dual energy radiation image, 1) different calibration models may be generated in response to the total thickness of the phantom for calibration and 2) different calibration models may be selected in response to the total thickness of the input subject. Accordingly, an estimation error may be reduced in regard to the thickness of the target estimated from the dual energy radiation image of the input subject. Also, the estimated thickness of the target may be a thickness of a predetermined material forming the input subject.

Accordingly, the estimated thickness may be similar to a pre-known thickness 1) even when a material of the input subject and a material of the phantom for calibration are different, 2) even when a dual energy radiation image of the input subject is damaged by noise or the like, or 3) even when a difference between the thickness of the phantom for calibration and a thickness of a material to be obtained from the dual energy radiation image of the input subject is remarkably large.

For example, the target estimating unit 150 estimates the target, for example thickness information, through the calibration using the selected calibration model in response to each combination of the intensities of the first and second energy images. The thickness information is shown in Table 4 below.

TABLE 4

| | 15 | 20 | 24 | . . . |
|---|---|---|---|---|
| 30 | 12 mm | 13 mm | 14 mm | . . . |
| 35 | 13 mm | 15 mm | 17 mm | . . . |
| 39 | 14 mm | 17 mm | 20 mm | . . . |

In other words, referring to Table 4, when the input subject has a predetermined total thickness, an actual thickness of 1) the first material, for example, adipose tissue, which the input subject is formed of, is estimated to be 15 mm if the intensity of the first energy image is 20 and 2) the intensity of the second energy image is 35.

The display unit 170 may display the thickness information of the target, for example, the first material, estimated by the target estimating unit 150 through the calibration according to each combination in 3-dimensions (3D).

The storage unit 190 may store target information that is estimated by the target estimating unit 150 through the calibration according to each combination.

The estimated target information may be transmitted to a transmitter that transmitted the parameter of the input subject or to the remote medical image system through the communicator, by wire or wirelessly.

FIG. 2 is a block diagram of the calibration model generating unit 100 of FIG. 1, according to an example embodiment. The calibration model generating unit 110 may include a test image generating unit 210, an intensity-target mapping unit 230, and a learning unit 250. In the example embodiment, the intensity-target mapping unit 230 and the learning unit 250 may be implemented by at least one processor.

Referring to FIG. 2, the test image generating unit 210 may obtain the dual energy radiation image of the test subject, and may extract and provide the parameter of the test subject from the dual energy radiation image to the intensity-target mapping unit 230. The intensities of the first and second energy images in the dual energy radiation image of the test subject may be provided as the parameter of the test subject.

The intensity-target mapping unit 230 may map each combination of the intensities of the first and second images in the dual energy radiation image of the test subject to the actual thickness of the predetermined material forming the test subject in each combination to the target. In the example embodiment, mapping results may be stored as a lookup table.

The learning unit 250 may learn the intensity-target data set provided by the intensity-target mapping unit 230 by applying the regression analysis to the intensity-target data set. Thus, the learning unit may generate the calibration model for the intensity-target data set.

FIG. 3 is a block diagram of the calibration model generating unit 110 of FIG. 1, according to another example embodiment. The calibration model generating unit 110 may include a test image generating unit 310, an additional information input unit 320, an intensity-target mapping unit 330, and a learning unit 350. The calibration model generating unit 110 of FIG. 3 is substantially identical to the calibration model generating unit 110 of FIG. 2, except that the additional information input unit 320 may add the total thickness of the test subject as the additional information.

Referring to FIG. 3, the intensity-target mapping unit 330 may map each combination of the intensities of the first and second energy images in the dual energy radiation image of the test subject to the actual thickness of the predetermined material forming the test subject in each combination to the target, according to the total thickness of the test subject. Mapping results may be stored as a lookup table according to the total thickness of the test subject.

The learning unit 350 may learn the intensity-target data set provided by the intensity-target mapping unit 330 by applying the regression analysis to the intensity-target data set. Thus, the calibration model for the intensity-target data set may be generated according to the total thickness of the test subject.

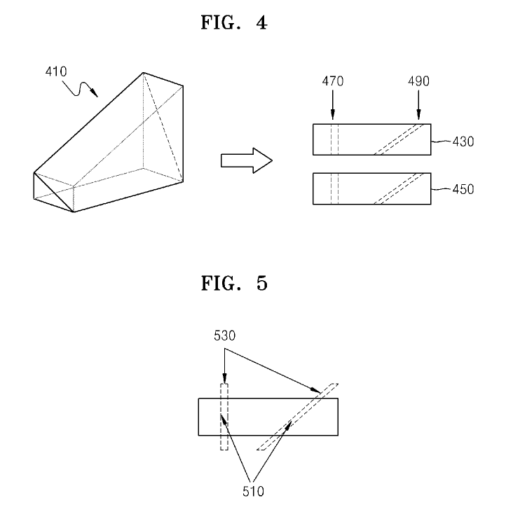

FIG. 4 is a diagram illustrating a phantom 410 for calibration including a continuous variable thickness. The diagram illustrates a method of selecting a calibration model, according to an example embodiment.

Referring to FIG. 4, a dual energy radiation image may be obtained based on the phantom 410 for calibration, which shows all ratios that two materials may have based on various total thicknesses, and a first energy image 430 and a second energy image 450 are separated from the dual energy radiation image. If the material forming the test subject and the material forming the input subject are substantially the same, vertical areas 470 may be selected from the first and second energy images 430 and 450 to be compared with the calibration model to perform intensity-target mapping, during a target estimating process, for example, while estimating thicknesses of the two materials by comparing the calibration model and the dual energy radiation image of the input subject. On the other hand, if the material of the input subject is different from the material of the test subject or the materials are the same but the densities of the input subject and the test subject are different, a material ratio or a thickness according to the materials may be calculated by projecting the input subject onto the material of the test subject. However, since the materials or densities are different, slanting areas 490 may be selected from the first and second energy images 430 and 450 to be compared to the calibration model, thereby performing intensity-target mapping. In other words, a degree of inclination of the slanting areas 490 selected in the first and second energy images 430 and 450 may be determined based on the material of the input subject in comparison with the material of the test subject. Also, a thickness area in the phantom 410 may be determined in relation to the slanting areas 490.

FIG. 5 is a diagram for describing data within a range and data outside the range. Referring to FIG. 5, in the first or second energy image of the test subject, intensity existing within the first or second energy image may be included in a range 510 displayable as the phantom for calibration, whereas intensity existing outside the first or second energy image may be included in a range 530 undisplayable as the phantom for calibration. Thus, when an intensity value exists in the range 510, a thickness coefficient of each material may be indicated by a positive number, and when the intensity value exists in the range 530, the thickness coefficient of each material may be indicated by a negative number.

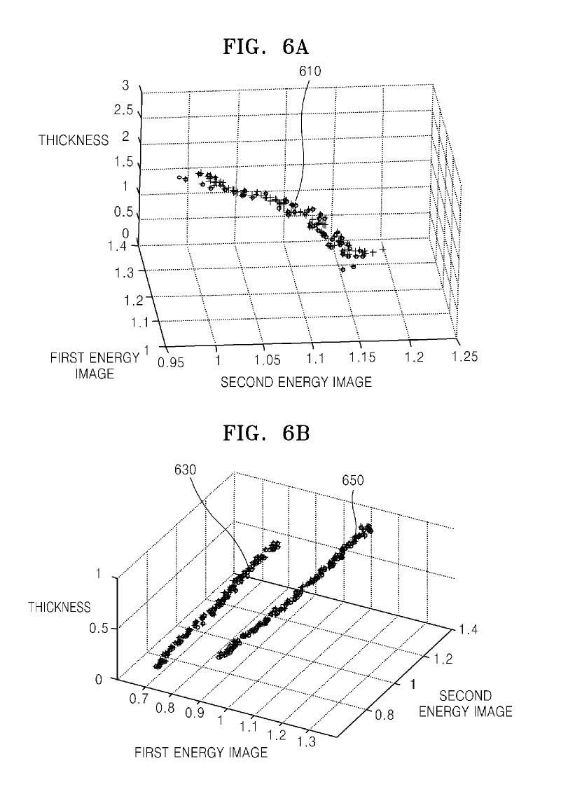

FIGS. 6A and 6B are graphs illustrating intensity-thickness relations mapped with respect to a single total thickness and two types of a total thickness, respectively. In other words, FIGS. 6A and 6B are graphs respectively showing calibration models 610, and 630 and 650. Referring to FIGS. 6A and 6B, a relation between the intensity of the first energy image, the intensity of the second energy image, and the thickness of the predetermined material may show a nonlinear characteristic. When an input and an output has a nonlinear characteristic, as shown in FIGS. 6A and 6B, the SVR performing the regression analysis in the same manner as in the intensity-target mapping may be applied. When the SVR is applied, data for each intensity of the dual energy radiation image of the phantom for calibration may be stored in an internal memory, and a weight required for the regression analysis may be calculated for the data for each intensity of the dual energy radiation image. The calculated weight and the data for each intensity may be learned to generate the intensity-thickness relations, as shown in, for example, the calibration models 610, 630 and 650. Then, when data for an intensity of a dual energy radiation image of a predetermined input subject is given, a value closest to the data may be output from an intensity-thickness data set used while generating the calibration model, by referring to the pre-learned and generated calibration model.

Meanwhile, as shown in FIG. 6B, the two different calibration models 630 and 650 may be generated even when a difference between total thicknesses of two phantoms for calibration is less than 1 cm, and an input subject having a corresponding total thickness may be selected. For example, when the two phantoms for calibration are formed of the same material, and the difference between the total thicknesses is less than 1 cm, values of the intensities of the first and second energy images may overlap and may be difficult to classify from each other. Thus, information for the total thickness of the phantom for calibration may be added as additional information, and an estimation error may be reduced even when the values of the intensities of the first and second energy images overlap each other.

Accordingly, the phantom for calibration, which is able to deal with various total thicknesses is required, and thus, for example, the phantom 410 of FIG. 4, which includes all combinations of two materials with respect to various total thicknesses, is formed. The total thickness of the phantom for calibration may be measured by using a well known method, and may be directly measured by a compression paddle in mammography.

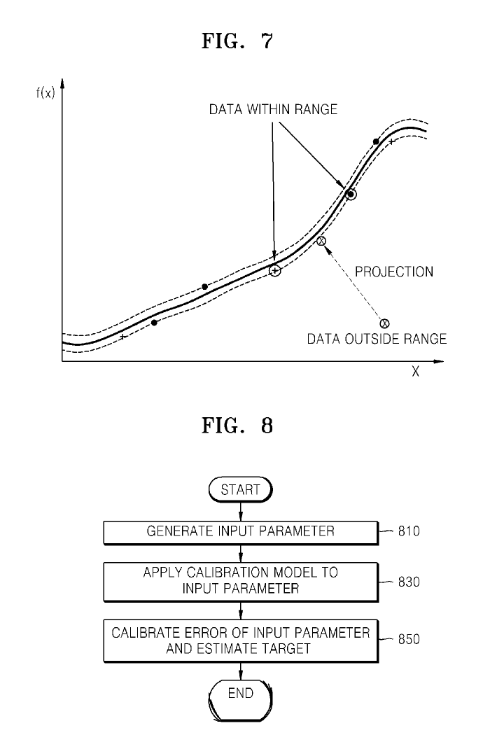

FIG. 7 is a graph illustrating an image calibration method using SVR according to an example embodiment. Referring to FIG. 7, when the intensity of the dual energy radiation image of the input subject is known, the intensity may be calibrated by mapping the intensity to a thickness corresponding to a nearest intensity by referring to a calibration model that is pre-learned and generated, and an intensity-thickness data set used while generating the calibration model. Accordingly, even when a value of the intensity of the dual energy radiation image of the input subject is not within a predetermined range, the intensity may not be mapped to a thickness having an abnormal value.

Also, in SVR, the regression analysis may be performed on a data distribution by using a kernel assuming nonlinearity, and thus a fitting error may be remarkably reduced even when an intensity-target relation of a subject to be imaged may be very nonlinear.

Also, since the total thicknesses of the phantom for calibration and input subject are used as parameters for generating the calibration model, a fitting error may be remarkably reduced even for the input subject having a different total thickness from the phantom for calibration.

FIG. 8 is a flowchart illustrating a method of processing an image, according to an example embodiment. The method may be performed by at least one processor, except an operation that uses specific hardware, such as, for example, a radiography detector.

Referring to FIG. 8, a parameter of an input subject, for example, an input parameter, may be generated in operation 810. The input parameter may include intensities of first and second energy images with respect to a same location in a dual energy radiation image of the input subject. Also, when a total thickness of a test subject is used while generating a calibration model using the test subject, the input parameter may further include a total thickness of the input subject.

In operation 830, the calibration model may be applied to the input parameter generated in operation 810. Thus, when the total thickness of the input subject is included in the input parameter, a calibration model corresponding to the total thickness of the input subject may be selected.

In operation 850, an error of the input parameter may be calibrated by applying the calibration model in operation 830, and a target corresponding to the calibrated input parameter, for example, a thickness of a predetermined material forming the input subject, may be estimated.

As described above, according to the one or more of the above example embodiments, even when error data outside a normal range is provided as an input parameter while processing a dual energy radiation image, the input parameter may be calibrated by projecting the input parameter onto a location nearest to the error data within the normal range. Accordingly, a desired target, for example, a thickness of a predetermined material forming an input subject, may be accurately obtained from the dual energy radiation image of the input subject.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing an image, the method comprising:
generating a calibration model by learning an intensity-target data set obtained from a parameter of a test subject; and
estimating a target, the estimating including applying the calibration model to a parameter of an input subject and calibrating the parameter of the input subject.

2. The method of claim 1, wherein the parameter of the test subject is intensity obtained from a dual energy radiation image of a phantom for calibration, and the parameter of the input subject is intensity obtained from a dual energy radiation image of the input subject.

3. The method of claim 2, wherein the parameter of the test subject comprises additional information about the phantom for calibration, and the parameter of the input subject comprises additional information about the input subject.

4. The method of claim 3, wherein:
the additional information is information about total thicknesses of the phantom for calibration and the input subject; and
different calibration models are selected according to the total thickness of the input subject.

5. The method of claim 1, wherein the generating comprises learning the intensity-target data set by using support vector regression (SVR).

6. The method of claim 2, wherein the phantom for calibration is formed by overlapping at least two ramp wedge phantoms formed of at least two materials.

7. The method of claim 1, further comprising, when the parameter of the input subject exists outside an intensity range used while generating the calibration model, projecting the parameter of the input subject within the intensity range used while generating the calibration model, and calibrating the parameter of the input subject with an intensity closest to the parameter of the input subject.

8. An apparatus for processing an image, the apparatus comprising:
a calibration model generating unit configured to generate a calibration model by learning an intensity-target data set obtained from a parameter of a test subject; and
a target estimating unit configured to estimate a target, the estimating including applying the calibration model to a parameter of an input subject and calibrating the parameter of the input subject.

9. The apparatus of claim 8, wherein the calibration model generating unit comprises:
an intensity-target mapping unit configured to obtain the intensity-target data set by mapping intensity and the target obtained from the parameter of the test subject; and
a learning unit configured to learn the intensity-target data set by applying a regression analysis to the intensity-target data set.

10. The apparatus of claim 8, wherein the parameter of the test subject is intensity obtained from a dual energy radiation image of a phantom for calibration, and the parameter of the input subject is intensity obtained from a dual energy radiation image of the input subject.

11. The apparatus of claim 10, wherein the parameter of the test subject comprises additional information about the phantom for calibration, and the parameter of the input subject comprises additional information about the input subject.

12. The apparatus of claim 11, wherein:
the additional information includes information about total thicknesses of the phantom for calibration, and input subject; and
different calibration models are selected according to the total thickness of the input subject.

13. The apparatus of claim 10, wherein, when the parameter of the input subject exists outside an intensity range used while generating the calibration model, the target estimating unit projects the parameter of the input subject within the intensity range used while generating the calibration model, and calibrating the parameter of the input subject with an intensity closest to the parameter of the input subject.

14. A medical image system employing the apparatus of claim 8, wherein the parameters of the test subject and the input subject are respectively intensities obtained from a radiation image.

15. The medical image system of claim 14, wherein the radiation image comprises at least a first energy image and a second energy image.

16. The medical image system of claim 14, wherein the apparatus is disposed in a remote place.

17. The method of claim 6, wherein one of the two materials is polycarbonate and another of the two materials is polyethylene.

18. The apparatus of claim 10, wherein:
the phantom for calibration is formed by overlapping at least two ramp wedge phantoms formed of at least two materials; and
one of the two materials is polycarbonate and another of the two materials is polyethylene.

19. A method of processing an image, the method comprising:
generating an input parameter including intensities of first and second energy images;
applying a calibration model to the generated input parameter;
calibrating an error of the input parameter by applying the calibration model; and
estimating a target based on the calibrated input parameter and the error.
